(19) United States
(12) Patent Application Publication
(10) Pub. No.: US 2026/0251454 A1
(43) Pub. Date: Aug. 27, 2026

(54) METHOD FOR OPERATING A SENSOR SYSTEM AND SENSOR SYSTEM

(71) Applicant: Robert Bosch GmbH, Stuttgart (DE)

(72) Inventors: Jochen Erb, Geislingen (DE); Rui Zhang, Eningen Unter Achalm (DE); Timo Heikkilae, Hyvinkää (FI); Juergen Gut, Tuebingen (DE)

(21) Appl. No.: 19/456,395

(22) Filed: Jan. 22, 2026

(30) Foreign Application Priority Data
Feb. 4, 2025 (DE) 10 2025 104 074.5

(51) Int. Cl. G01C 21/16; G01P 7/00

(52) U.S. Cl. CPC G01C 21/16; G01P 7/00

(57) ABSTRACT

A computer-implemented method for operating a sensor system. The method includes: receiving second sensor values acquired at a second measurement time; executing a filter module on first sensor values acquired at an earlier first measurement time and ascertaining a partial output value for the first measurement time; and ascertaining an output value of the sensor system for the second measurement time based on the second sensor values and on the partial output value using an analysis algorithm. A sensor system is also described.

### CROSS REFERENCE

The present application claims the benefit under 35 U.S.C. § 119 of Germany Patent Application No. 10 2025 104 074.5 filed on Feb. 4, 2025, which is expressly incorporated herein by reference in its entirety.

### FIELD

The present disclosure relates to a method for operating a sensor system and to a sensor system.

### BACKGROUND INFORMATION

Certain methods for operating sensor systems and sensor systems are described in the related art.

### SUMMARY

It is an object of the present disclosure to provide an improved method for operating a sensor system and an improved sensor system.

The object is achieved by the method and the sensor system of the present disclosure. Advantageous embodiments are disclosed herein.

According to one aspect of the present disclosure, a computer-implemented method for operating a sensor system is provided. According to an example embodiment, the method comprises: receiving second sensor values acquired at a second measurement time;
executing a filter module on first sensor values acquired at an earlier first measurement time and ascertaining a partial output value for the first measurement time; and
ascertaining an output value of the sensor system for the second measurement time by performing an integration of the partial output value taking into account the second sensor value for a time interval between the first measurement time and the second measurement time by means of an analysis algorithm.

This can achieve the technical advantage that an improved method for operating a sensor system can be provided. For this purpose, second sensor values of the sensor system are acquired at a current second measurement time. In addition, a filter module is executed on first sensor values of the sensor system acquired at an earlier measurement time, and a partial output value is generated based thereon.

The partial output value represents an output value of the sensor system for the earlier first measurement time. Based on the partial output value and the second sensor values of the current second measurement time, an analysis module performs an integration over a time interval between the first and second measurement times, and based thereon, the actual output value of the sensor system is generated. The output value of the sensor system represents the current output value at the second measurement time.

By using the filter module, various additional functions, such as calculating an error or offset or other states of the sensor system, can be estimated or performed. By executing the filter module on the earlier first sensor values and by executing the current output value at the second measurement time based on the integration of the partial output value generated by the filter module and the current second sensor values, the output value can be calculated based on the partial output value.

If, for example, the partial output value is corrected by the filter module by the ascertained offset, the corresponding offset correction is included in the calculation of the output value at the second measurement time. The output value can thus be automatically corrected accordingly with the corrections of the partial output value.

By executing the filter module on the earlier first sensor values, it is possible to ensure that the output value of the sensor system can be output without time delay at the second measurement time, i.e., at the current measurement time. This avoids or minimizes any time delay in the output of the current output value of the sensor system.

Since the filter module does not need to be executed based on the current second sensor values, a longer execution time can be provided for the filter module. This can reduce the computing power required to execute the filter module.

According to one example embodiment of the present disclosure, the first sensor values comprise first speed values and/or first acceleration values of the first measurement time, wherein the second sensor values comprise second speed values and/or second acceleration values of the second measurement time, wherein the partial output value comprises a first position value and/or a first speed value of the first measurement time, wherein the output value comprises a second position value and/or a second speed value of the second measurement time, and wherein ascertaining the output value comprises:
performing an integration of a product between the first position value of the partial output value and the second speed value and/or the second acceleration value of the second sensor values over the time interval between the first and second measurement times, and ascertaining the second position value of the output value; and/or
performing an integration of a product between the first speed value of the partial output value and the second acceleration value of the second sensor values over the time interval between the first and second measurement times, and ascertaining the second speed value of the output value or of the second sensor values.

This can achieve the technical advantage that the method according to the present disclosure allows for precise position determination and/or precise speed determination based on the first and second sensor values.

According to an example embodiment, for position ascertainment, the filter module calculates, based on the first sensor values, a first position value as part of the partial output value. The first position value describes a position at the first measurement time. Taking into account a second speed value or a second acceleration value of the second sensor values, each representing the speed or acceleration at the second measurement time, the second position can be ascertained as part of the output value by correspondingly integrating the product between the first position value and the second speed value and/or second acceleration value over the time interval between the first and second measurement times. In this case, the second position value describes the current position at the second measurement time.

To calculate the speed, an integration is performed by first calculating a first speed value as part of the partial output value based on the first sensor values using the filter module. In this case, the first speed value describes a speed at the first measurement time.

By performing the integration, over the time interval between the first and second measurement times, of the product between the first speed value and the second acceleration value of the second measurement values, which describes the current acceleration of the system at the second measurement time, the second speed value can be ascertained as part of the output value. In this case, the second speed value describes the current speed of the system at the second measurement time.

The described integrations allow for a precise ascertainment of the current position and/or the current speed based on the first and second sensor values, taking into account the partial output value calculated by the filter module.

According to one example embodiment, the first sensor values comprise rotation rate values of the first measurement time and the second sensor values comprise second rotation rate values of the second measurement time, wherein the partial output value comprises a first orientation value of the first measurement time and the output value comprises a second orientation value of the second measurement time, and wherein ascertaining the output value comprises:
performing an integration of a product between the first orientation value of the partial output value and the second rotation rate value of the second sensor values over the time interval between the first and second measurement times, and ascertaining the second orientation value of the output value; and/or
ascertaining first and/or second linear acceleration values by mapping the first and/or second acceleration values into a world coordinate system and subtracting Earth's gravitational acceleration.

This can achieve a technical advantage that, in addition to the position values and/or speed value, an orientation value can be ascertained as part of the output value. In this case, the ascertainment is carried out analogously by performing a corresponding integration of the partial output value multiplied by the corresponding two sensor values over the time interval between the first and second measurement times. To determine the speed, a time integration of the ascertained linear acceleration is performed. To determine the position, a double time integration of the linear acceleration is carried out.

An advantage of the integration is analogous to the embodiments described above, in that by taking into account the partial output value calculated by the filter module, the accuracy of the partial output value can be transferred to the output value through the integration. Offset corrections that have been incorporated into the partial output value by the filter module during the ascertaining of the partial output value can be carried over by the integration and thus flow into the output value of the sensor system.

This allows a correspondingly precise output value of the sensor system to be ascertained, which can be provided without substantial time delay at the second measurement time.

According to one example embodiment, the first measurement time is earlier in time than the second measurement time by the predefined time interval, wherein the method is carried out continuously over time by defining a current time as the second measurement time and a measurement time earlier in time by the predefined time interval as the first measurement time, and/or wherein further measurement times are arranged between the first measurement time and the second measurement time, and wherein the sensor values of the further measurement times are taken into account in the integration.

This can achieve a technical advantage that, by selecting the time interval between the first and second measurement times, the present method can be adapted to the system to be operated. In this case, the length of the time interval can be selected such that the first sensor values on which the filter module is executed are placed further back into the past, or closer to the second measurement time, relative to the current second sensor values of the current second measurement time.

When the method is continuously carried out during operation of the sensor system, the first and second measurement times are each shifted stepwise into the future according to the sampling intervals of the sensor value acquisition, such that the second measurement time represents the current time of the sensor system and the first measurement time is shifted into the past by the predefined time interval.

By arranging further measurement times between the first and second measurement times, at which further measurement times further sensor values are acquired, it is possible to take into account not only the partial output value and the second sensor values in the integrations described above, but also the sensor values of the additional measurement times between the first and second measurement times. This allows for further refinement of the integration and the corresponding output values generated.

According to one example embodiment, the method further comprises:
storing the first sensor values in a memory unit of the sensor system; and/or wherein the first sensor values are preprocessed before being stored in the memory unit, and/or wherein ascertaining the partial output value comprises:
ascertaining an error value of the sensor system based on the first sensor values by the filter module.

This can achieve the technical advantage that, by storing the first sensor values in the sensor unit of the sensor system, the filter module can be executed on the first sensor values acquired at the earlier first measurement time.

By ascertaining the error value of the sensor system using the filter module, a sensor offset can be taken into account in the calculation of the output value. As described above, when the error value is ascertained during the calculation of the partial output value by the sensor module, the corresponding error value is likewise taken into account in the calculation of the output value in the form of the integration of the partial output value.

This allows the calculation of the output value taking into account the sensor offset and the output of the output value corrected accordingly by the sensor offset at the current output time.

According to one example embodiment, the method further comprises:
performing a data evaluation of the second sensor values and ascertaining a change of state of the sensor system, wherein the data evaluation is performed during the execution of the filter element; and
signaling the change of state to the filter module, wherein the filter module is configured to take the change of state into account in the calculation of the partial output value and/or in the ascertaining of the sensor error.

This can achieve a technical advantage that, by performing the data evaluation, a change in the state of the sensor system during the execution of the filter module can be ascertained.

By indicating the change of state to the filter module, the filter module can take the change of state into account when calculating the partial output value. Here, for example, the calculation of the sensor offset by the filter module can be set when the change of state indicates that the sensor system is no longer in the rest state. This allows the precision of the ascertained partial output value and, based thereon, the precision of the output value to be increased.

According to one example embodiment, the filter module comprises a Kalman filter and/or a particle filter and/or a Monte Carlo simulation method.

This can achieve a technical advantage of providing a high-performance filter module that is configured to calculate or predict a corresponding partial output value based on the relevant sensor values.

According to one aspect of the present disclosure, a sensor system is provided having at least one sensor element, a memory unit and an analysis unit having at least one filter module and an analysis algorithm, wherein the analysis unit is configured to carry out the method for operating a sensor system according to one of the above-described embodiments, and/or wherein the sensor element is configured as a sensor from the following list: acceleration sensor, speed sensor, rotation rate sensor.

This can achieve a technical advantage that an improved sensor system can be provided, which is configured to carry out the method according to the present disclosure having the technical advantages described above. The sensor system can be configured in particular as an acceleration sensor, speed sensor or rotation rate sensor.

According to one aspect of the present disclosure, a computing unit is provided that is configured to carry out the method for operating a sensor system according to one of the above-described embodiments.

According to one aspect of the present disclosure, a computer program product is provided, comprising commands that, when the program is executed by a data processing unit, cause the data processing unit to carry out the method for operating a sensor system according to one of the above-described embodiments.

Example embodiments of the present disclosure are described with reference to the figures.

### BRIEF DESCRIPTION OF THE DRAWINGS

FIG. 1 is a schematic representation of a sensor system according to one example embodiment.

FIG. 2 is a further schematic representation of a sensor system according to a further example embodiment.

FIG. 3 is a further schematic representation of a sensor system according to a further example embodiment.

FIG. 4 is a graphical representation of a method for operating a sensor system according to one example embodiment, including graphs a), b), and c).

FIG. 5 is a flowchart of a method for operating a sensor system according to one example embodiment.

FIG. 6 is a further flowchart of the method for operating a sensor system according to one example embodiment.

FIG. 7 is a further flowchart of the method for operating a sensor system according to one example embodiment.

FIG. 8 is a schematic representation of a computer program product, according to an example embodiment.

### DETAILED DESCRIPTION OF EXAMPLE EMBODIMENTS

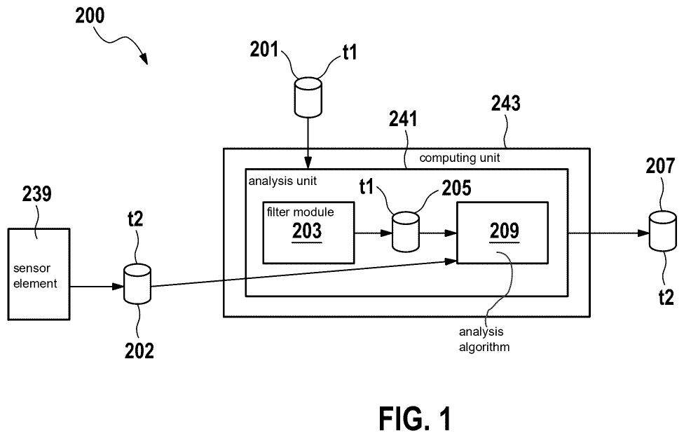

FIG. 1 is a schematic representation of a sensor system 200 according to one example embodiment.

The sensor system 200 comprises a sensor element 239 and an analysis unit 241 that can be executed on a computing unit 243. The analysis unit 241 comprises a filter module 203 and an analysis algorithm 209.

According to one embodiment, the filter module 203 comprises a Kalman filter and/or a particle filter and/or a Monte Carlo simulation method.

To carry out the method according to the present disclosure for operating the sensor system 200 and to ascertain an output value 207 of the sensor system 200, second sensor values 202 of the sensor element 239 are first received by the analysis unit 241. The second sensor values 202 were acquired at a current second measurement time t2 by the sensor element 239.

Additionally, the filter module 203 is executed on first sensor values 201 acquired at an earlier first measurement time t1. In this case, the first sensor values 201 describe the state of the sensor system 200 at an earlier first measurement time t1.

Based on the first sensor values 201, the filter module 203 ascertains a partial output value 205. The partial output value 205 describes an output value of the sensor system 200 at the first measurement time t1. The partial output value 205 thus represents the output of sensor system 200 that the sensor system 200 would have output based on the first sensor values 201 at the first measurement time t1.

To generate the current output value 207, the analysis algorithm 209 performs an integration of the partial output value 205 of the filter module 203, taking into account the second sensor values 202, over a time interval between the first and second measurement times t1, t2.

The output value 207 is ascertained as a result of the integration. The output value 207 represents the output of the sensor system 200 at the current second measurement time t2.

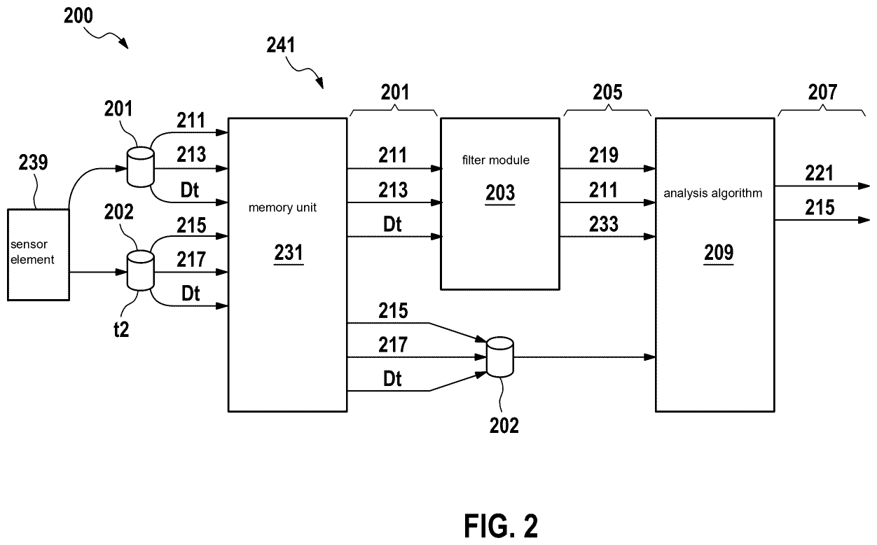

FIG. 2 is a schematic representation of a sensor system 200 according to one embodiment.

The embodiment shown is based on the embodiment in FIG. 1 and comprises all the features described there. In the embodiment shown, the sensor system 200 comprises a memory unit 231.

In the memory unit 231, at least the first sensor values 201 acquired at the first measurement time t1 are temporarily stored. Between the first measurement time t1 at which the first sensor values 201 are acquired and the second measurement time t2 at which the second sensor values 202 are acquired, the first sensor values 201 are provided to the filter module 203 for calculating the partial output value 205.

In this case, the execution of the filter module 203 on the first sensor values 201 to calculate the partial output value 205 can be effected analogously to the reception of the second sensor values 202 at the second measurement time t2.

In the embodiment shown, the first sensor values 201 comprise first speed values 211 and/or first acceleration values 213, which represent the speed and/or acceleration of the system at the first measurement time t1. Similarly, the second sensor values 202 comprise second speed values 215 and/or second acceleration values 217, which represent the speed and/or acceleration of the system at the second measurement time t2.

According to the embodiment shown, the partial output value 205 comprises a first position value 219 and/or the first speed value 211. The first position value 219 describes the position of the system 200 at the first measurement time t1. Similarly, the output value 207 includes a second position value 221 and/or the second speed value 215. The second position value 221 describes the position of the system 200 at the second measurement time t2.

Based on the first sensor values 201, the filter module 203 calculates the partial output value 205, comprising the first position value 219 and/or the first speed value 211.

In the embodiment shown, the filter module 203 further ascertains an error value 233 of the sensor system 200 during the calculation of the partial output value 205. The error value 233 can, for example, comprise a sensor offset of the sensor system 200.

To ascertain the output value 207, the analysis algorithm 209 performs an integration based on the values of the partial output value 205 and the second sensor values 202.

To calculate the second position value 221 of the output value 207, the analysis algorithm 209 performs an integration of the first position value 219 of the partial output value 205 multiplied by the second speed value 215 of the second sensor values 202 over the time interval Dt between the first and second measurement times t1, t2.

By the corresponding integration, assuming a constant speed of the system, the second position value 221 of the output value 207, which describes the position of the system 200 at the second measurement time t1, is calculated based on the first position value 219 of the partial output value 205, which represents the position of the system 200 at the first measurement time t1.

To calculate the second speed value 215 of the output value 207, the analysis algorithm 209 performs an integration of the first speed value 211 of the partial output value 205 multiplied by the second acceleration value 217 of the second sensor values 202 over the time interval Dt between the first and second measurement times t1, t2.

By calculating the integration of the product between the first speed value 211 of the partial output value 205 and the second acceleration value 217 of the second sensor values 202, assuming a constant acceleration of the system 200, the change in speed from the first speed value 211 at the first measurement time t1 to the second speed value 215 at the second measurement time t2 is ascertained.

The second speed value 215 is calculated primarily by the integration described above when the first and/or second sensor values 201, 202 do not comprise speed values, but instead primarily have the first and second acceleration values 213, 217.

In the integration described, the calculated error value 233 of the partial output value 205 can be taken into account. For this purpose, compensations of the second sensor values 202 with respect to the calculated error value 233 can be carried out. This allows the correspondingly calculated output value 207 to likewise be corrected according to the error value 233 calculated by the filter module 203.

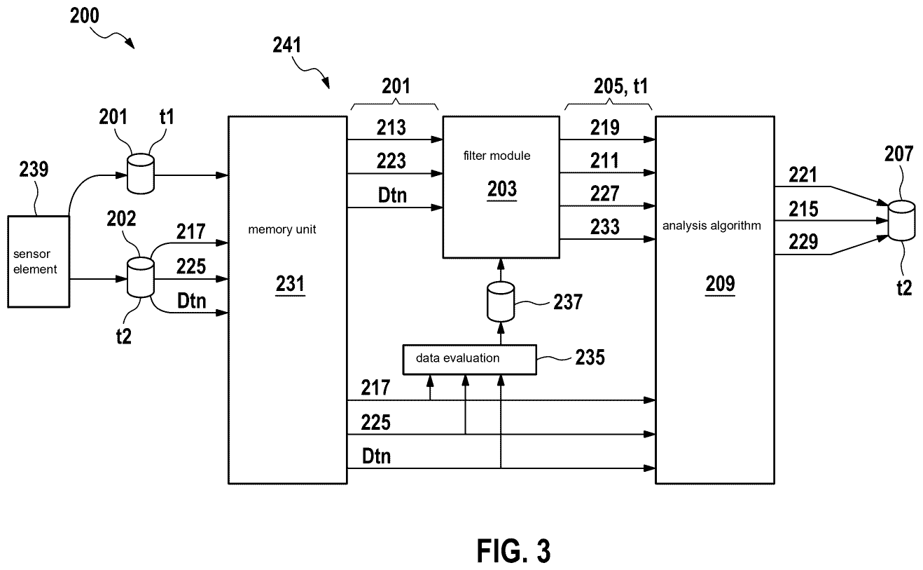

FIG. 3 is a further schematic representation of a sensor system 200 according to one embodiment.

The embodiment shown is based on the embodiment in FIG. 2 and comprises all the features shown there.

In the embodiment shown, the analysis unit 241 further comprises a data evaluation 235. The data evaluation 235 is performed, during the execution of the filter module 203, on the first sensor values 201 and on the second sensor values 202. In this case, the data evaluation 235 is configured to ascertain a change of state 237 of the system 200.

The change of state can, for example, describe an acceleration of the system 200 from a state of rest to an accelerated motion.

In this case, the ascertained change of state 237 of the system 200 can be provided to the filter module 203 as additional information by the data evaluation 235. The filter module 203 is configured to take the ascertained change of state 237 of the system into account in the calculation of the partial output value 205.

For the stated example of the change of state in which the accelerated motion of the system 200 from the state of rest to the accelerated state is described, the filter module 203 can terminate the calculation of the error value 233 in the form of the sensor offset. Instead of the newly calculated error value 233, the filter module 203 can output the error value 233 calculated at an earlier measurement time.

In the embodiment shown, a rotational movement of the sensor system 200 is described. To this end, the first sensor values 201 comprise the first acceleration value 213 and a first rotation rate value 223. Analogously, the second sensor values 202 comprise the second acceleration value 217 and a second rotation rate value 225.

The partial output value 205 in turn comprises the first position value 219, the first speed value 211, a first orientation value 227 and the error value 233. The output value 207 comprises the second position value 221, the second speed value 215 and a second orientation value 229.

Based on the first sensor values 201, the filter module 203 in turn calculates the partial output value 205.

Based on the partial output value 205 and the second sensor values 202, the output value 107 is ascertained by performing the described integrations using the analysis algorithm 209.

The calculation of the second position value 221 is in turn carried out by integrating the first position value 219 of the partial output value 205 multiplied by the second speed value 215 and a linear acceleration at the second measurement time t2.

The second speed value 215 is in turn calculated by integrating the first speed value 211 of the partial output value 205 multiplied by the linear acceleration at the second measurement time t2 over the time interval Dt between the first and second measurement times t1, t2.

In the embodiment shown, the second orientation value 229 of the output value 207 is calculated based on the first orientation value 227 of the partial output value 205 and the second rotation rate value 225 of the second sensor values 202.

To calculate the linear acceleration at the second measurement time t2, the second acceleration value 217 of the second sensor values 202 is mapped into a world coordinate system and corrected for Earth's gravitational acceleration.

In the embodiment shown, further sensor values are acquired at additional measurement times between the first measurement time t1 and the second measurement time t2. In this case, the further sensor values, in addition to the second sensor values 202, are also taken into account in the described integrations.

In this case, the integrations are performed in such a way that the particular value of the partial output value 205 that represents the corresponding measured variable at the first measurement time t1 is used as the initial value of the integration. The subsequent sensor values are integrated according to the respective measurement times with increasing time intervals from the first measurement time t1. The second sensor values 202 of the second measurement time t2 are taken into account in the integration as the last integration term.

In the embodiment shown, the first and second sensor values 201, 202, as well as the further sensor values, in addition to the acceleration values 213, 217 and rotation rate values 223, 225, additionally comprise a time interval Dtn. In this case, the time interval Dtn describes a step size between two successive measurement times. The time interval Dt between the first measurement time t1 and the second measurement time t2 is given here by a sum of the time intervals Dtn for the number of measurement times between the first and second measurement times

$${Orientation}_{t 1 + t} = {Orientation}_{t 1 + t - 1} + Δ t * rotation {rate}_{t 1 + t}$$

The above equation states that the orientation value at a time t1+t corresponds to the sum of the orientation value at the time t1+t and to the product of the time intervals Δt and the rotation rate value at the time t1+t. The time t1+t describes any measurement time between the first measurement time t1 and the second measurement time t2. The time t1+t−1 is a time that is one measurement cycle earlier than the time t1+t. The time interval Δt corresponds to the time interval between times t1+t and t1+t−1.

$${Position}_{t 1 + t} = {Position}_{t 1 + t - 1} + Δ t * {speed}_{t 1 + t} + 1 / 2 * Δ {t}^{2} * linear {acceleration}_{t 1 + t}$$

The above equation states that the position value at the time t1+t corresponds to the sum of the position value at the time t1+t−1, to the product of Δt and to the speed value at the time t1+t, and to the product of Δt squared and to the linear acceleration at the time t1+t.

$${Speed}_{t 1 + t} = {Speed}_{t 1 + t - 1} + Δ t * linear {acceleration}_{t 1 + t}$$

The above equation states that the speed value at the time t1+t corresponds to the sum of the speed value at the time t1+t−1 and to the product of the time interval Δt and to the linear acceleration value at the time t1+t.

In this case, the linear acceleration can be ascertained from the measured acceleration values, taking into account Earth's gravitational acceleration, by projection into world coordinates and a corresponding correction with respect to Earth's gravitational acceleration.

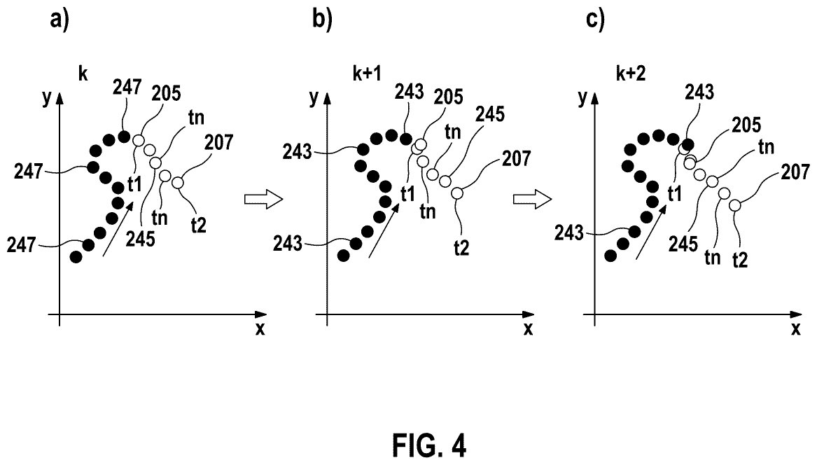

FIG. 4 is a graphical representation of a method for operating a sensor system 200 according to one embodiment.

The graphs a), b), c) show the calculation of the output value 207 based on the partial output value 205 for different times k, k+1, k+2 according to the method steps described above.

In the embodiment shown, the method is carried out continuously over time by defining, for each further measurement time at which additional sensor values are acquired, the current measurement time as the second measurement time t2 and by defining the correspondingly acquired sensor values as second sensor values 202.

In this case, the first measurement time t1 represents a measurement time in the past at which sensor values were acquired and that is offset in time from the second measurement time t2, which represents the current measurement time of the system 200, by the defined time interval Dt.

With continuing measurement duration, the first and second measurement times t1, t2 are each shifted forward stepwise, such that the current measurement time is always defined as the second measurement time t2 and the first measurement time t1 is separated in time from the second measurement time t2 by the predefined time interval Dt. This is shown in graphs a) to c), in which a current measurement time is added from graph a) to graph b) and from graph b) to graph c).

The graphs shown further show further measurement times tn between the first measurement time t1 and the second measurement time t2, at which additional sensor values are acquired by the sensor element 239. In the embodiment shown, the additional sensor values acquired between the first and second measurement times t1, t2 are integrated as additional integration terms in the integrations for calculating the output value 207, which integration terms are integrated between the partial output value 205, which represents the first integration term, and the second sensor values 202, which represent the last integration term.

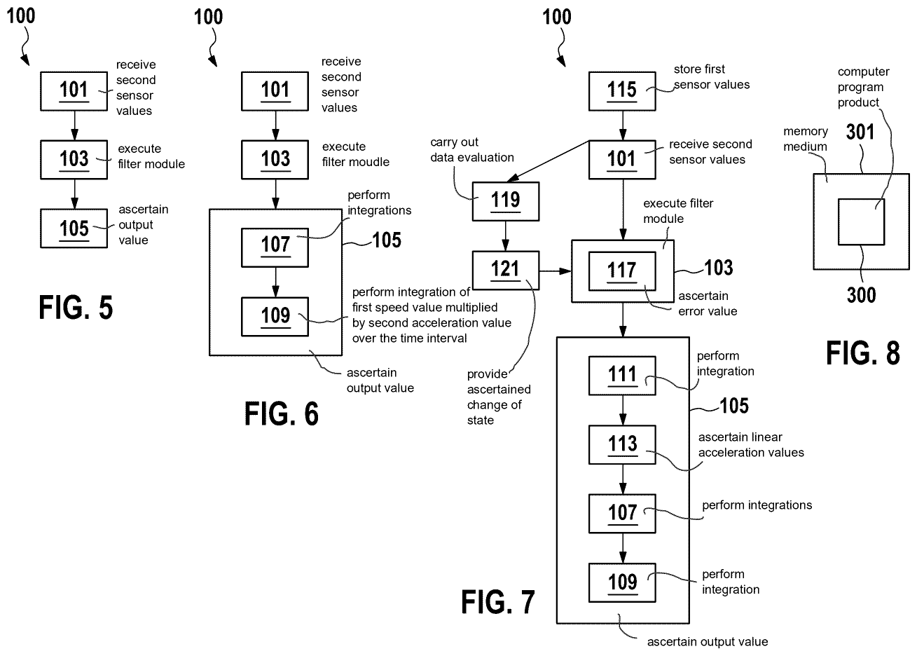

FIG. 5 is a flowchart of a method 100 for operating the sensor system 200 according to one embodiment.

To operate the sensor system 200, in a first method step 101 the second sensor values 202 are received at the second measurement time t2.

In a further method step 103, the filter module 203 is executed on the first sensor values 201 acquired at the earlier first measurement time t1, and the partial output value 205, which describes the state of the system 200 at the first measurement time t1, is generated.

In a further method step 105, the output value 207 of the sensor system 200, which describes the state of the system 200 at the second measurement time t2, is ascertained by performing the integration of the partial output value 205 taking into account the second sensor values 202 over the time interval Dt between the first and second measurement times t1, t2.

FIG. 6 is a further flowchart of the method 100 for operating a sensor system 200 according to one embodiment.

The embodiment shown is based on the embodiment in FIG. 5 and comprises all the method steps described there.

In the embodiment shown, to calculate the output value 207 in a method step 107, the integration of the first position value 219 multiplied by the second speed value 215 and/or the second acceleration value 217 of the second sensor values 202 is performed over the time interval Dt between the first and second measurement times t1, t2, and the second position value 221 of the output value 207 is ascertained on the basis thereof.

In method step 109, the integration of the first speed value 211 multiplied by the second acceleration value 217 over the time interval Dt is performed to ascertain the second speed value 215.

FIG. 7 is a further flowchart of the method 100 for operating a sensor system 200 according to one embodiment.

The embodiment in FIG. 7 is based on the embodiment in FIG. 6 and comprises all the method steps described there.

In a method step 115, the first sensor values 201 are stored in the memory unit 231.

In a method step 119, the data evaluation 235 of the second sensor values 202 is carried out and a change of state 237 is optionally ascertained.

In method step 121, the ascertained change of state 237 is provided to the filter module 203.

In the embodiment shown, in a method step 117, the filter module 203 ascertains the error value 233 in the calculation of the partial output value 205.

In the embodiment shown, the movements of system 200 are configured as rotational movements, and the speeds are configured as rotation rates. Accordingly, in a method step 111, the integration of the sum of the first orientation value 227 and a product of the second rotation rate value 225 of the second sensor values 202 and the time interval Dt between the first and second times and/or between successive times was performed and the second orientation value 229 of the output value 207 was ascertained.

By summing the first orientation value 227 and a product of the second rotation rate value 225 of the second sensor values 202 and the time interval Dt between the first and second times, the rotation of the orientation value 227 with the second rotation rate value 225 over the time interval Dt is described in the second orientation value 229.

In a method step 113, based on the first and/or second acceleration values of the first and/or second sensor values 201, 202, corresponding linear acceleration values are ascertained, by mapping the acceleration values into a world coordinate system and subtracting the Earth's gravitational acceleration.

According to one embodiment, the first and/or second sensor values 201, 202 can be pre-processed before being stored in the memory unit 231 in order to reduce the required memory capacity.

FIG. 8 is a schematic representation of a computer program product 300, comprising commands that, when the program is executed by a data processing unit, cause the data processing unit to carry out the method 100 for operating a sensor system 200.

In the embodiment shown, the computer program product 300 is stored on a memory medium 301. Here, the memory medium 301 can be any memory medium from the related art.

What is claimed is:

1. A computer-implemented method for operating a sensor system, comprising the following steps:
receiving second sensor values acquired at a second measurement time;
executing a filter module on first sensor values acquired at an first measurement time and ascertaining a partial output value for the first measurement time, the first measurement time being earlier than the second measurement time; and
ascertaining an output value of the sensor system for the second measurement time by performing an integration of the partial output value, taking into account the second sensor value for a time interval between the first measurement time and the second measurement time using an analysis algorithm.

2. The method according to claim 1, wherein the first sensor values include first speed values and/or first acceleration values of the first measurement time, wherein the second sensor values include second speed values and/or second acceleration values of the second measurement time, wherein the partial output value includes a first position value and/or a first speed value the first measurement time, wherein the output value includes a second position value and/or a second speed value of the second measurement time, and wherein the ascertaining of the output value includes:
performing an integration of a product between the first position value of the partial output value and: (i) the second speed value and/or (ii) the second acceleration value of the second sensor values over the time interval, and ascertaining the second position value of the output value; and/or
performing an integration of a product between the first speed value of the partial output value and the second acceleration value of the second sensor values over the time interval and ascertaining the second speed value of the output value or of the second sensor values.

3. The method according to claim 2, wherein the first sensor values includes first rotation rate values of the first measurement time and the second sensor values include second rotation rate values of the second measurement time, wherein the partial output value includes a first orientation value of the first measurement time and the output value includes a second orientation value of the second measurement time, and wherein the ascertaining of the output value includes:
performing an integration of a sum of the first orientation value of the partial output value and a product of the second rotation rate value of the second sensor values with the time interval between the first and second measurement times and ascertaining the second orientation value of the output value; and/or
ascertaining first and/or second linear acceleration values by mapping the first and/or second acceleration values into a world coordinate system and subtracting Earth's gravitational acceleration.

4. The method according to claim 2, wherein: (i) the first measurement time is earlier in time than the second measurement time by the time interval, wherein the method is carried out continuously over time by defining a current time as the second measurement time and a measurement time earlier in time by the time interval as the first measurement time, and/or (ii) further measurement times are arranged between the first measurement time and the second measurement time, and wherein the sensor values of the further measurement times are taken into account in the integration.

5. The method according to claim 1, wherein:
the method further comprises storing the first sensor values in a memory unit of the sensor system; and/or
the first sensor values are preprocessed before being stored in the memory unit, and/or
the ascertaining of the partial output value includes ascertaining an error value of the sensor system based on the first sensor values by the filter module.

6. The method according to claim 1, further comprising:
performing a data evaluation of the second sensor values and ascertaining a change of state of the sensor system, wherein the data evaluation is performed during the execution of the filter element; and
indicating the change of state to the filter module, wherein the filter module is configured to take the change of state into account in the ascertaiing of the partial output value and/or in the ascertaining of a sensor error.

7. The method according to claim 1, wherein the filter module includes a Kalman filter and/or a particle filter and/or a Monte Carlo simulation method.

8. A sensor system, comprising:
at least one sensor element;
a memory unit; and
an analysis unit including at least one filter module and an analysis algorithm, wherein the analysis unit is configured to carry out a method for operating the sensor system including the following steps:
receiving second sensor values acquired at a second measurement time,
executing a filter module on first sensor values acquired at an first measurement time and ascertaining a partial output value for the first measurement time, the first measurement time being earlier than the second measurement time, and
ascertaining an output value of the sensor system for the second measurement time by performing an integration of the partial output value, taking into account the second sensor value for a time interval between the first measurement time and the second measurement time using an analysis algorithm.

9. The sensor system according to claim 8, wherein the sensor element is configured as a sensor from the following list: acceleration sensor, speed sensor, rotation rate sensor.

10. A device, comprising:
a computing unit configured to carry out a method for operating a sensor system, the method including the following steps:
receiving second sensor values acquired at a second measurement time,
executing a filter module on first sensor values acquired at an first measurement time and ascertaining a partial output value for the first measurement time, the first measurement time being earlier than the second measurement time, and
ascertaining an output value of the sensor system for the second measurement time by performing an integration of the partial output value, taking into account the second sensor value for a time interval between the first measurement time and the second measurement time using an analysis algorithm.

11. A non-transitory computer-readable medium on which is stored commands for operating a sensor system, the commands, when executed by a data processor, causing the data processor to perform the following steps comprising:
receiving second sensor values acquired at a second measurement time;
executing a filter module on first sensor values acquired at an first measurement time and ascertaining a partial output value for the first measurement time, the first measurement time being earlier than the second measurement time; and
ascertaining an output value of the sensor system for the second measurement time by performing an integration of the partial output value, taking into account the second sensor value for a time interval between the first measurement time and the second measurement time using an analysis algorithm.
